(19) United States
(12) Patent Application Publication
(10) Pub. No.: US 2006/0288822 A1
(43) Pub. Date: Dec. 28, 2006

(54) Ratchet wrench

(76) Inventor: Peter Langas, Itasca, IL (US)

Correspondence Address: SKOKOS LAW GROUP, LLC, 1100 JORIE BOULEVARD, SUITE 220, OAK BROOK, IL, 60523, US

(21) Appl. No.: 11/158,542

(22) Filed: Jun. 22, 2005

(51) Int. Cl. B25B 13/00; B25G 1/00; B25B 23/16

(52) U.S. Cl. 81/59.1; 81/177.7

(57) ABSTRACT

An improved wrench for adjusting fasteners. In one embodiment, the wrench comprises a body or a handle having at least two ends. One or more heads are located on at least one of the ends. The head has an inner and outer surface that form an opening large enough to accept a fastener. Pockets or recesses are located on the head inner surface and each pocket can accept at least one pin or ball. A cage or other securing device is sized to fit inside of the opening and movably secure the pins or balls in the pockets or recesses. Also, an insert may be provided to accept the fastener and whereby the insert is positioned inside the cage or securing device so that the insert can rotate with respect to the head. In one form of the invention, a retaining device may hold the insert in position.

### FIELD OF THE INVENTION

The present invention relates to a ratchet wrench, and more particularly to ratchet wrenches that provide for an enhanced flexibility and usability of the ratchet wrench and provide for use in a broad range of applications.

### BACKGROUND OF THE INVENTION

Ratchet wrenches of various types are well known in the art. Such devices are typically used for tightening or loosening a nut, bolt or other fastener device. However, previous ratchet wrenches have some inherent disadvantages. One of the disadvantages with existing wrenches is that they require gears to create a ratcheting motion, engage and lock in place which limits the flexibility and usability of the wrench in various applications.

The present invention overcomes these and other problems inherent in existing ratchet wrenches. The present invention provides a ratchet wrench that has a ratcheting head that does not require a paw or gears to engage and create the ratcheting motion. In one embodiment, the present invention uses a combination of three parts consisting of a body, pins or balls, and insert to lock the wrench in position when ratcheting. Because this type of wrench does not need teeth to engage and lock in place, it can have distinctly different outer profiles such as, for example, a close ended, an open ended and a pipe/line wrench opening. The insert may have a polygonal inner profile that engages objects such as bolts, nuts or other fasteners. The engaging action that is realized can be used in a variety of different positions such as, for example, right or left ratcheting and neutral. This allows the tool to rotate in both directions without the need to remove the tool from the fastener. In another embodiment, another benefit of this ratcheting mechanism and realized motion is to eliminate the insert and have the pin(s) or ball(s) wedge directly against the fastener. This configuration can be used for metric, standard and strip fasteners with the same wrench.

### BRIEF SUMMARY OF THE INVENTION

A wrench for adjusting fasteners. In one embodiment, the wrench comprises a body or a handle having at least two ends. One or more heads are located on at least one of the ends. The head has an inner and outer surface that form an opening large enough to accept a fastener. Pockets or recesses are located on the head inner surface and each pocket can accept at least one pin or ball. A cage or other securing device is sized to fit inside of the opening and movably secure the pins or balls in the pockets or recesses. Also, an insert may be provided to accept the fastener and whereby the insert is positioned inside the cage or securing device so that the insert can rotate with respect to the head. In one form of the invention, a retaining device may hold the insert in position.

### BRIEF DESCRIPTION OF THE DRAWINGS

FIG. 1 is a perspective cut away view of one embodiment of one end of the ratchet wrench of the present invention;

FIG. 2 is an exploded view of the ratchet wrench of FIG. 1;

FIG. 3 is an exploded cut away view of another embodiment of one end of a ratchet wrench;

FIG. 4A is a perspective view of a ratchet wrench;

FIG. 4B is an exploded perspective view of the ratchet wrench of FIG. 4A;

FIG. 5A is a perspective view of yet another embodiment of a ratchet wrench;

FIG. 5B is an exploded perspective view of the ratchet wrench of FIG. 5A.

### DETAILED DESCRIPTION OF THE INVENTION

While the present invention is susceptible of embodiments in various forms, there is shown in the drawings and will hereinafter be described some exemplary and non-limiting embodiments, with the understanding that the present disclosure is to be considered an exemplification for the invention and is not intended to limit the invention to the specific embodiments illustrated. In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

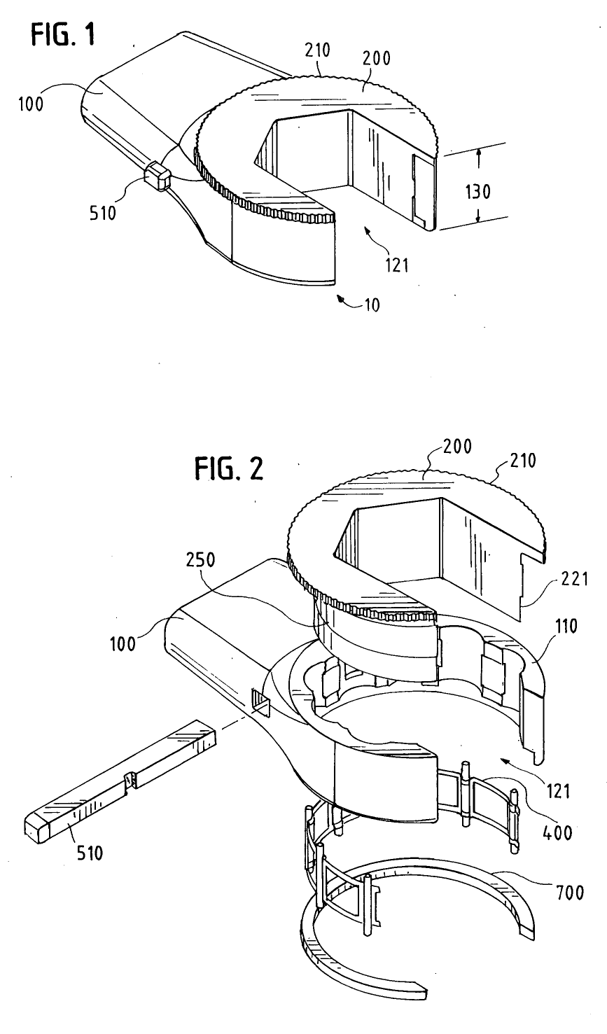

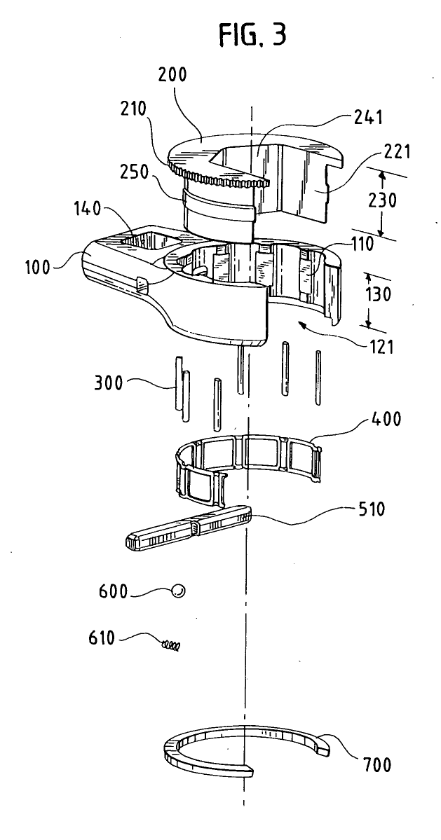

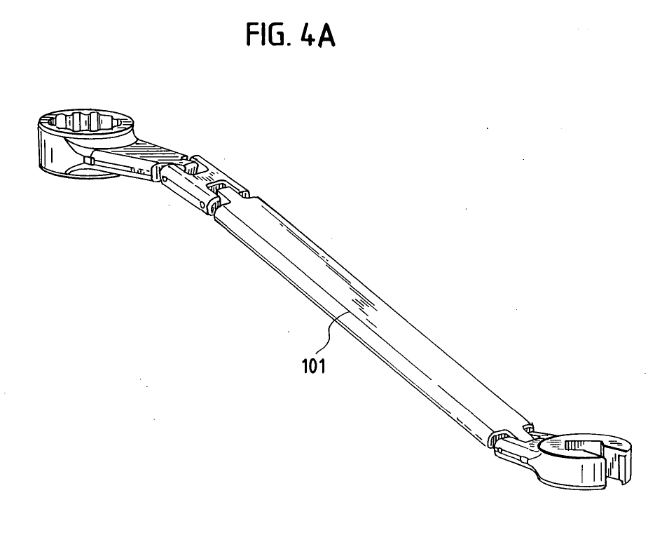

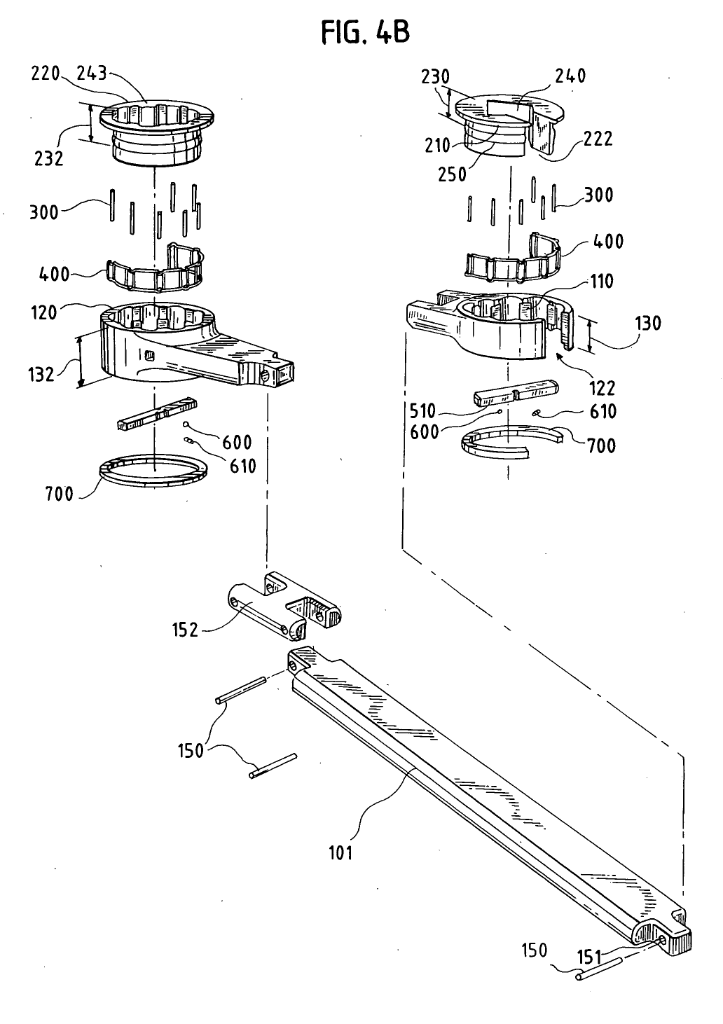

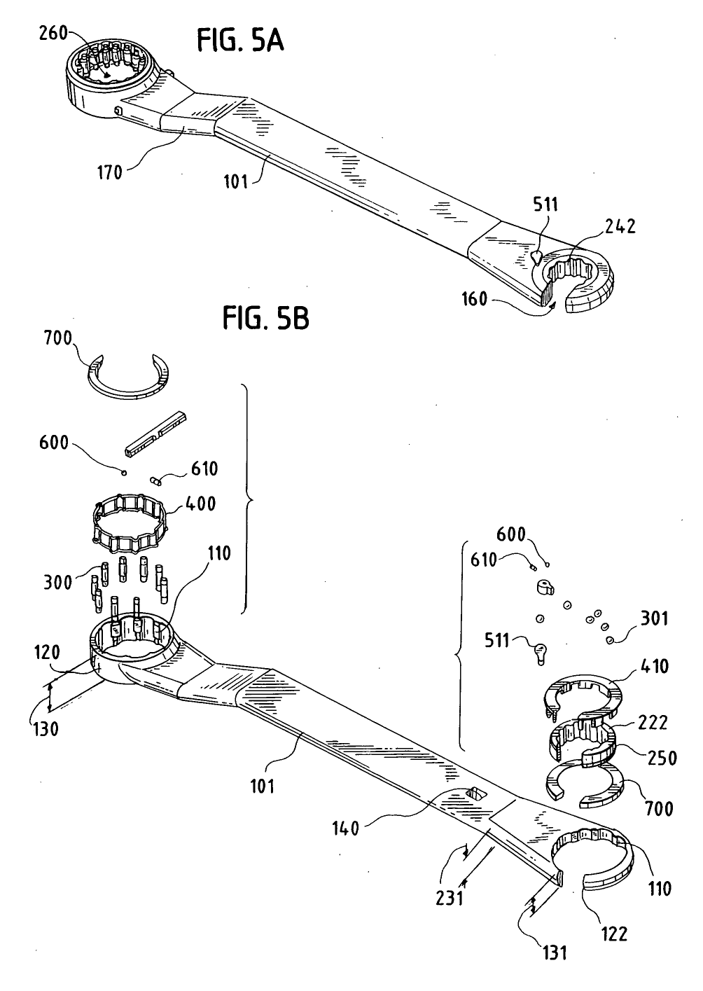

FIG. 1 shows a perspective cut away view of one embodiment of one end of the ratchet wrench of the present invention. FIG. 2 shows an exploded view of the ratchet wrench of FIG. 1. FIG. 3 shows an exploded view of a ratcheting head with a crows foot wrench. It has a six point open-ended head in which the body is moved by a standard square hole drive. FIGS. 4A and 4B show a perspective view and an exploded view of a combination wrench. One end has a four point pipe/line with a single flex head. The other end has a splined deep well close end with a double flex head. FIGS. 5A and B show a perspective view and an exploded view of another embodiment of a combination wrench. One end has a 12-point thin angle open end with a slotted cage and a top mounted lever. The other end has a close end with no insert and an offset head. The body has a square hole to engage a standard drive such as a crows foot.

Referring to FIGS. 1, 2, 3, shown is body 100 of wrench 10. As shown in FIG. 3, body 100 has several features such as, for example, pockets 110 or recesses, open ended wrench 121, head thickness 130 which can vary, for example; standard thickness, thin thickness or thick thickness; and square drive 140. A crows foot uses standard square drive 140 to move the body 100 in a ratcheting motion. Further shown is knurly portion 210, open-ended portion 221, mating surface 250, ribbed cage 400, and retainer clip 700.

FIGS. 4A and B shows body 101 having pockets 110, line/pipe ended head openings 122, head thickness 130, optional flexible head 151, and flex joint 152 having hinge pins 150. In this configuration, the body 101 acts as a handle that can be grasped by a user's hand. In one embodiment the standard overall length is that of a typical combination wrench. The length can also vary from extra long to stubby to reach and maneuver in tighter spots. The pocket 110 holds the locking pins 300 in place. In yet other embodiments, pins 300 may be substituted by balls. The body 100 can have as few as three pockets 110. The shape of the pocket 110 causes a ramping or wedging effect as the pins/balls 300 are positioned in the pockets 110. The head of the body 100 can have different sized and shaped line ended openings 122. For example, as shown in FIG. 3, open-ended wrench 121 has a head opening that is as large as the cross section of a fastener (the distance between two parallel sides). The thickness of the head can be a standard 130 dimension equal to the height of a fastener. Some fasteners come in different heights and the head may or may not be exactly the identical thickness. Thin head 131, as shown in FIGS. 5A and B, may be used for constricted spaces. Thick head 132, for example as shown in FIGS. 4A and 4B, may be used for added strength and deep well applications.

FIG. 4B shows hinge pins 150 that allow the heads to pivot to enable the heads to fit in cramped or awkward to maneuver spaces. In one form, the wrench can have a single flex head hinge 151 or multiple hinge pins 152 allowing more angular configuration positions.

FIGS. 5A and B show body 100 having pockets 110, line/pipe ended openings 122, and thin head thickness 131. In this configuration, the body 100 acts as a handle that can be grasped by a user's hand. In one embodiment the standard overall length is that of a typical combination wrench. The length can also vary from extra long to stubby to reach into tighter spots. The pockets 110 hold the locking pins 300 or balls 301 in place. In one embodiment, the body 100 can have as few as three pockets. In yet other embodiments, it can have more than three pockets 110. The shape of the pocket 110 causes a ramping or wedging effect when the pins 300 or balls 301 are positioned in the pockets 110. The head of the body 100 can have different sized and shaped openings 122. In one embodiment, as shown in FIGS. 1, 2 and 3, open-ended 121 may have an opening as large as the cross section of a fastener (the distance between two parallel sides). The thickness of the head can be a standard 130 dimension equal to the height of a fastener. Some fasteners come in different heights and the head may not be exactly the identical thickness. Thin head 131 may be used for constricted hard to reach spaces.

FIGS. 5A and B show one embodiment of an angle head 160 that can be used on an open ended wrench 121 or on a line/pipe ended 122 head. The opening may or may not be perpendicular to the handle and may be at some degree rotated off to the side. This configuration may be used for hard to reach places where a wrench cannot reach a fastener directly straight on, but can only reach the fastener from a side position. FIGS. 5A and B show an offset head portion 170 where body 100 is positioned parallel to the head and is located on a different plane than the head. This type of configuration may be used when a user cannot get his/her fingers around to grip the body when a fastener is located adjacent a surface and the space between the body 100 and the surface is restricted. FIGS. 5A and B also show a standard drive square hole 140 in the handle of the body which acts the same as a crows foot but is instead used in a combination wrench.

Referring to FIGS. 3, 4A and B and 5A and B shown is insert 200 of wrench 10. Insert 200 is the part of the wrench that engages a fastener. Insert 200 rotates and therefore tightens or loosens a fastener as the body 100 is ratcheted around the fastener. In one embodiment, insert 200 has multiple features including but not limited to knurled portion 210, outer profiles (openings) close-ended 220, open-ended 221, or line/pipe ended 222; standard, thin, or thick thickness 230, 231, or 232; inter profile; 4 point 240, 6 point 241, 12 point 242 or spline portion 243; mating surface 250. The knurled surface 210 allows the insert to be turned by hand with a finger without turning body 100.

Knurled surface 210 has two primary purposes. First, it can be used to speed up the ratchet wrench the time it takes to move the fastener up or down long thread without moving the ratcheting device. Second, it can be used on open ended 221 or line/pipe ended 222 inserts to lineup the openings on the body open ended 121 or the body line/pipe ended 122 to remove the wrench. In alternate embodiment, the insert 200 may have three outer profiles. Close ended insert 220 has no openings. This allows the tool to grasp the fastener on all sides. In yet another form of the invention, this is the safest way to move a fastener because an even force is established on all sides. In one form of the invention, open-ended insert 221 has an opening that is as large as the cross section of the fastener (the distance between two parallel sides). In one embodiment, and for some applications, this is the least preferred method because it has the least amount of surface contacting the fastener. Fasteners can be easily rounded off (stripped) if there is not proper contact between the fastener and the wrench.

For certain applications, open-ended wrenches are most often used because they are the only ones that can fit in tight spaces. Line/pipe ended insert 222 may have an opening but in some embodiments it is much smaller than the open ended insert 221. The opening is as small as possible to allow only clearance for the wrench to get through the diameter of an object like a tube/pipe, shaft, bolt, etc. This configuration allows the insert to contact more surface area of the fastener and minimizes the risk of rounding off (striping) a fastener head compared to the risk by an open ended insert 221. One reason for this is because most tube or pipes use a soft material, for example, brass or aluminum for their fasteners. For example, in one form, a six sided (hex) fastener has six points and all but one has contact with the fastener making it the preferred method over an open-ended insert if the available space allows. The thickness of the insert can be standard dimension 230 equal to the height of a fastener. Fasteners are available in a variety of different heights. Thin insert 231 may be used for constricted spaces or short fasteners such as a jam nut for example. Thick insert 232 may be used for added strength and deep well applications. Deep well applications can also be used when a fastener is positioned below the working surface.

The inner profile of an insert is the negative polygonal shape of the fastener. It is the portion that mates with the fastener. Following are examples of common types of fasteners but not limited to specific applications that will dictate the profile configuration. FIGS. 4A and B show a 4 point insert 240. FIG. 3 shows a 6 point insert 241. FIGS. 5A and 5B show a 12 point insert 242. FIGS. 4A and B also show a spline insert 243. Other examples of insert configurations may be Torx® or star fasteners, PCV fittings used in plumbing applications, Army/Navy (A/N) fasteners used in airplanes, racing applications and military equipment, etc.

The insert wedging or mating surface 250 is the surface the locking pins 300 or balls 301 contact. In one embodiment, the smooth surface is a significant difference between other ratchets/wrenches that utilize gears. As a result of this combination, the ratcheting action does not have to wait or pause for the next tooth to lock in place. FIG. 5B shows one embodiment of a closed ended wrench with no insert 260. This embodiment functions by the locking pins 300 which move outward until they grab the fastener. By using no insert, the locking pins 300 or balls 301 that may adjust to accept standard, metric or stripped fasteners. Because each pin/ball will continually adjust and move out until it grasps some object, even a round object or an object without corners may be grasped.

FIGS. 3 and 4B show locking pins 300. The pins are wedged between body 100 and insert 200 causing the insert 200 and the body 100 to move as one. The locking pins 300 are pushed back in the body pocket 110 by the insert 200 when the wrench is moving in the non-force transmitting ratchet motion. When no insert 260 is used the pins are wedged and pushed back by the fastener. In yet another embodiment, FIG. 5B shows locking balls 301 can be used in a thin head 131 body for wrenches that require a lower profile. In yet other embodiments, the wrench can have as few as three locking pins 300 or balls 301.

FIGS. 3, 4B and 5B shows a ribbed cage 400 or slotted cage 410. In one embodiment, the cage has two functions. The first function is to hold the locking pins 300 or balls 301 in place when an opening in an insert rotates by the locking pins or balls. For example, in an open-ended 221 or a line/pipe ended 222 insert application, the cage holds the pins in place in an embodiment of a wrench that does not have an insert 260. The second function is to move the locking pins 300 or balls 301 in up to three positions right, left or neutral. The cage shown in FIGS. 3, 4B and 5B has a rib design 400 and FIG. 5 also shows a slotted 410 design.

FIGS. 3, 4A and B and 5A and B shows three position lever 500 or two position lever 501 that is used to change position of the cage. In one form of the invention, the lever may have three positions, for example, right, left and neutral. A two position lever would only have right and left positions. The lever can be side mounted 510 or top mounted 511.

FIGS. 3, 4B and 5B show detent pins or balls 600 that are used to hold levers 510 or 511 in place after a position has been selected. In one embodiment, the detent may have two components, for example, the detent pin or balls 600 and a spring 610. The spring 610 may have multiple functions, for example, first to put pressure on the lever 510 or 511 to hold the lever in a selection position. Second, to create tension on the cage 400 or 410 that gets transferred to the locking pins 300 or balls 301. FIGS. 3, 4B and 5B also show a retainer clip 700 that is used to hold the insert 200 in place.

During use, a user experiences multiple benefits using the ratchet wrench. For example, the wrench requires less sweep than existing wrenches that use a gear thereby enabling ease of operation. The wrench is reversible and has a one-way clutch and can have multiple positions, right ratcheting, left ratcheting and neutral. In yet other forms of the invention, a retaining device may hold the insert, pins or cage in position. In one embodiment, since no insert is required, the locking pins/balls can grip standard, metric, stripped or odd size fasteners with the same wrench. The standard square drive located in the handle allows the use of a torque wrench and other square drives allow easy access to fasteners. In another embodiment, open or line/pipe wrench with an opening angle other than parallel to the handle provides for easy access to fasteners. Further, deep welled inserts may be provided for access to fasteners below the working surface. In one embodiment, balls are used for locking wedges. As little as three locking pins/balls give the capability of a large opening (approximately 120 degrees). Also, in other forms, an extra thin head can be provided for tight spaces or jam nuts.

Specific embodiments of novel methods and apparatus for construction of novel ratchet wrenches according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

What is claimed is:

1. A wrench for loosening or tightening fasteners, the wrench comprising:
a body having a first end and a second end;
at least one head positioned on the body at the first end;
the head having an inner surface and an outer surface and said surfaces forming an opening large enough to accept a fastener;
the inner surface defining a plurality of pockets formed to accept one or more pins;
a ribbed cage sized to fit inside of the opening and secure the pins in the pockets;
a retainer removably connected to one side of the head to maintain the ribbed cage in the opening; and
an insert defining an opening large enough to accept the fastener whereby the insert is positioned inside the ribbed cage so that the insert can rotate with respect to the at least one head.

2. The wrench of claim 1 wherein one pin is maintained in each of the plurality of pockets.

3. The wrench of claim 1 wherein the head is connected to the body by a joint that allows the head to pivot with respect to the body.

4. The wrench of claim 1 further comprising a lever movably located within the head whereby the lever is positioned adjacent the ribbed cage and controls the movement of the ribbed cage.

5. The wrench of claim 1 wherein the insert comprises a knurled portion that is positioned outside of the head opening when the insert is located within the head opening.

6. The wrench of claim 1 wherein the insert, the head, the cage and the retainer have an opening sized to accept a fastener whereby the fastener can be rotated wherein communication with the insert.

7. The wrench of claim 1 wherein the insert has a substantially smooth mating surface around its outer circumference which is in contact with the cage and pins.

8. A wrench for adjusting fasteners, the wrench comprising:
a body having a first end and a second end;
at least one head positioned on the body at the first end;
the head having an inner surface and an outer surface and said surfaces forming an opening large enough to accept a fastener;
the inner surface defining a plurality of pockets formed to accept one or more pins;
a ribbed cage sized to fit inside of the opening and secure the pins in the pockets; and
a means for retaining removably connected to one side of the head to hold the cage in the opening.

9. The wrench of claim 8 wherein one pin is maintained in each of the plurality of pockets.

10. The wrench of claim 8 wherein the head is connected to the body by a joint that allows the head to pivot with respect to the body.

11. The wrench of claim 8 further comprising a lever movably located within the head whereby the lever is positioned adjacent the ribbed cage and controls the movement of the ribbed cage.

12. The wrench of claim 8 wherein the head 1 the cage and the retainer can accept a fastener and whereby the fastener can be rotated.

13. The wrench of claim 11 further comprising a ball and spring removably communicating with the lever to control the movement of the cage within the head.

14. A wrench for adjusting fasteners, the wrench comprising:
a body having a first end and a second end;
at least one head positioned on the body at one of the ends;
the at least one head having an inner surface and an outer surface whereby said surfaces form an opening sized to accept a fastener;
the inner surface defining a plurality of pockets formed to accept one or more balls;
a means for movably securing the balls inside the pockets;
a means for retaining removably connected to the head to maintain the means for securing in the opening; and
insert defining an opening large enough to accept the fastener whereby the insert is positioned inside the means for movably securing so that the insert can rotate with respect to the at least one head.

15. The wrench of claim 14 whereby the means for movably securing is a slotted cage.

16. The wrench of claim 14 whereby the means for retaining is a retainer ring.

17. The wrench of claim 14 wherein one ball is maintained in each of the plurality of pockets.

18. The wrench of claim 14 wherein the head is connected to the body by a joint that allows the head to pivot with respect to the body.

19. The wrench of claim 14 further comprising a lever movably located within the head whereby the lever is positioned adjacent the means for movably securing and controls the movement of the means for movably securing.

20. The wrench of claim 14 wherein the insert, the head, the means for movably securing and the means for retaining have an opening sized to accept a fastener whereby the fastener can be rotated when in communication with the insert.

21. The wrench of claim 14 wherein the insert has a substantially smooth mating surface around its outer circumference which is in contact with the balls.

22. A wrench for adjusting fasteners, the wrench comprising:
a body having a first end and a second end;
at least one head positioned on the body at one end;
the head having an inner surface and an outer surface and an opening defined in the head whereby a fastener can fit in the opening;
the inner surface defining a plurality of recesses;
one or more wedging means located in the plurality of recesses;
a cage sized to fit inside of the opening and secure the wedging means in the recesses;
a retaining means removably connected to the head to maintain the cage in the opening; and
an insert defining an opening large enough to accept the fastener whereby the insert communicates with the cage so that the insert can rotate with respect to the at least one head.

23. The wrench of claim 22 further comprising a lever movably located within the head whereby the lever is positioned adjacent the cage and provides for the wrench to experience three ratcheting positions.

24. The wrench of claim 22 further comprising a standard square drive located in the body that can accept a torque wrench.

25. The wrench of claim 22 further comprising a deep well insert to communicate with a fastener located below a working surface.

26. The wrench of claim 22 wherein the one or more wedging means are one or more balls.

27. The wrench of claim 22 wherein the one or more wedging means are one or more pins.
